(19) United States
(12) Patent Application Publication
(10) Pub. No.: US 2021/0329020 A1
(43) Pub. Date: Oct. 21, 2021

(54) DETECTION RULE GROUP ADJUSTMENT APPARATUS AND COMPUTER READABLE MEDIUM

(71) Applicant: MITSUBISHI ELECTRIC CORPORATION, Tokyo (JP)

(72) Inventors: Aiko IWASAKI, Tokyo (JP); Kiyoto KAWAUCHI, Tokyo (JP); Kazuhiro ONO, Tokyo (JP); Takuya SHOYA, Tokyo (JP); Hiromitsu SHIRAI, Tokyo (JP); Hideaki IJIRO, Tokyo (JP)

(73) Assignee: MITSUBISHI ELECTRIC CORPORATION, Tokyo (JP)

(21) Appl. No.: 17/363,463

(22) Filed: Jun. 30, 2021

Related U.S. Application Data
(63) Continuation of application No. PCT/JP2019/040619, filed on Oct. 16, 2019.

(30) Foreign Application Priority Data
Feb. 21, 2019 (JP) 2019-029248

(51) Int. Cl. H04L 29/06; G06F 21/55

(52) U.S. Cl. CPC H04L 63/1416; G06F 21/554; G06F 21/552; H04L 63/1425

(57) ABSTRACT

An erroneous detection amount obtaining unit (110) obtains using an overall detection rule group corresponding to an overall phase group that configures a series of attack activities, an erroneous detection amount of each phase of when attack detection is performed. A final stages verification unit (121) verifies whether or not an erroneous detection amount of a final phases group satisfies a final stages limitation. An overall verification unit (123) verifies whether or not the erroneous detection amount of the overall phase group satisfies an overall limitation. In a case where the erroneous detection amount of the final phases group does not satisfy the final stages limitation, a final stages adjustment unit (122) adjusts a parameter value of each detection rule of a final stages detection rule group. In a case where the erroneous detection amount of the final phases group satisfies the final stages limitation and the erroneous detection amount of the overall phase group does not satisfy the overall limitation, an overall adjustment unit (124) adjusts a parameter value of each detection rule other than the final stages detection rule group.

### CROSS REFERENCE TO RELATED APPLICATIONS

This application is a Continuation of PCT International Application No. PCT/JP2019/040619, filed on Oct. 16, 2019, which claims priority under 35 u.s.c. 119(a) to patent application no. 2019-029248, filed in the Japan on Feb. 21, 2019, all of which are hereby expressly incorporated by reference into the present application.

### TECHNICAL FIELD

The present invention relates to an adjustment of a detection rule to detect a cyberattack.

### BACKGROUND ART

Conventionally, a detection rule has been created based on a communication log, a terminal log, and the like to detect a cyberattack. A detection result of an attack depends on a parameter or a threshold applied to the detection rule. To prevent an omission of detection and to control erroneous detection, setting a proper parameter and a proper threshold are necessary.

In Patent Literature 1, technology to determine a threshold of a detection rule is disclosed.

With regard to this technology, a communication log of a monitoring target network and a communication log when malware appears are analyzed based on an analysis rule and a tuning condition. Then, the threshold of the detection rule is determined according to an erroneous detection rate and an attack detection rate.

### CITATION LIST

### Patent Literature

Patent Literature 1: WO/2015/141630

### SUMMARY OF INVENTION

### Technical Problem

A log of an attack by malware can be acquired by a system that is a monitoring target actually being attacked or by the attack being reproduced using a simulation environment and the like. Logs that are actually gathered in the system that is the monitoring target, however, are mostly logs that are normal. Thoroughly reproducing existing attacks is difficult. With regard to an attack that is unknown, a log of the attack does not exist.

Even in a case where a log of an attack cannot be prepared, setting a threshold based on an erroneous detection count that a monitor, the monitor being a person that performs monitoring at a Security Operations Center (SOC) and the like, is able to allow per day is possible. In a case where monitoring, however, is to be performed using a plurality of detection rules together, to keep the erroneous detection count within an allowable range, a standard for when determining which detection rule to revise and how cannot be determined.

Among the monitors that perform monitoring at the SOC and the like, there is a person called an operator and a person called an analyst. Between the operator and the analyst, ability to respond to an alert that has been detected and a range of alerts that can be responded to differ.

In a series of attack activities by an attacker, a first phase is a well-known way of attack. And, responses to many of first phases are made into procedures. Consequently, even the operator is possible to respond to the first phase. On the other hand, making judgements and responding in final phases where the attack has progressed are difficult. Consequently, the analyst responds to the final phases. That is, personnel that respond change according to a degree of progress of the attack. Consequently, it is necessary to consider an erroneous detection count that the operator is able to respond to and an erroneous detection count that the analyst is able to respond to separately. Especially, it is necessary to take into consideration the erroneous detection count that the analyst is able to respond to in the final phases.

The present invention aims to enable adjustments to an erroneous detection count according to a degree of progress of an attack.

### Solution to Problem

A detection rule group adjustment apparatus of the present invention includes:

an erroneous detection amount obtaining unit to obtain using an overall detection rule group corresponding to an overall phase group that configures a series of attack activities, an erroneous detection amount of each phase of when attack detection is performed;

a final stages verification unit to verify based on an erroneous detection amount of each phase of a final phases group in the overall phase group, whether or not the erroneous detection amount of the final phases group satisfies a final stages limitation;

an overall verification unit to verify based on the erroneous detection amount of each phase of the overall phase group, whether or not the erroneous detection amount of the overall phase group satisfies an overall limitation;

a final stages adjustment unit, in a case where the erroneous detection amount of the final phases group does not satisfy the final stages limitation, to adjust a parameter value of each detection rule of a final stages detection rule group in the overall detection rule group; and

an overall adjustment unit, in a case where the erroneous detection amount of the final phases group satisfies the final stages limitation and the erroneous detection amount of the overall phase group does not satisfy the overall limitation, to adjust a parameter value of each detection rule other than the final stages detection rule group in the overall detection rule group.

### Advantageous Effects of Invention

According to the present invention, adjusting of a detection rule of each phase can be done according to a degree of progress of an attack. Therefore, it will be possible to adjust an erroneous detection amount according to the degree of progress of the attack.

### BRIEF DESCRIPTION OF DRAWINGS

FIG. 1 is a configuration diagram of a detection rule group adjustment system 200 according to Embodiment 1.

FIG. 2 is a configuration diagram of a detection rule group adjustment apparatus 100 according to Embodiment 1.

FIG. 3 is a flowchart of a detection rule group adjustment method according to Embodiment 1.

FIG. 4 is a flowchart of an erroneous detection amount obtaining process (S110) according to Embodiment 1.

FIG. 5 is a diagram illustrating overall detection rule group data 191 according to Embodiment 1.

FIG. 6 is a flowchart of a final stages verification process (S120) according to Embodiment 1.

FIG. 7 is a diagram illustrating limitation data 192 according to Embodiment 1.

FIG. 8 is a flowchart of a final stages adjustment process (S130) according to Embodiment 1.

FIG. 9 is a diagram illustrating adjustment rule data 193 according to Embodiment 1.

FIG. 10 is a diagram illustrating adjustment data 194 according to Embodiment 1.

FIG. 11 is a flowchart of an overall verification process (S140) according to Embodiment 1.

FIG. 12 is a flowchart of an overall adjustment process (S150) according to Embodiment 1.

FIG. 13 is a diagram illustrating the adjustment data 194 according to Embodiment 1.

FIG. 14 is a diagram illustrating a configuration example of the detection rule group adjustment system 200 according to Embodiment 1.

FIG. 15 is a configuration diagram of a detection rule group adjustment apparatus 100 according to Embodiment 2.

FIG. 16 is a flowchart of a detection rule group adjustment method according to Embodiment 2.

FIG. 17 is a flowchart of a final stages adjustment process (S230) according to Embodiment 2.

FIG. 18 is a diagram illustrating overall detection rule group data 191 according to Embodiment 2.

FIG. 19 is a diagram illustrating adjustment pattern data 195 according to Embodiment 2.

FIG. 20 is a diagram illustrating limitation data 192 according to Embodiment 2.

FIG. 21 is a diagram illustrating adjustment data 194 according to Embodiment 2.

FIG. 22 is a flowchart of an overall adjustment process (S250) according to Embodiment 2.

FIG. 23 is a diagram illustrating the adjustment data 194 according to Embodiment 2.

FIG. 24 is a hardware configuration diagram of a detection rule group adjustment apparatus 100 according to Embodiments.

### DESCRIPTION OF EMBODIMENTS

In the embodiments and in the drawings, the same elements or corresponding elements are denoted by the same reference signs. Description of elements denoted by the same reference signs as the elements described will be suitably omitted or simplified. Arrows in the drawings mainly indicate flows of data or flows of processes.

### Embodiment 1

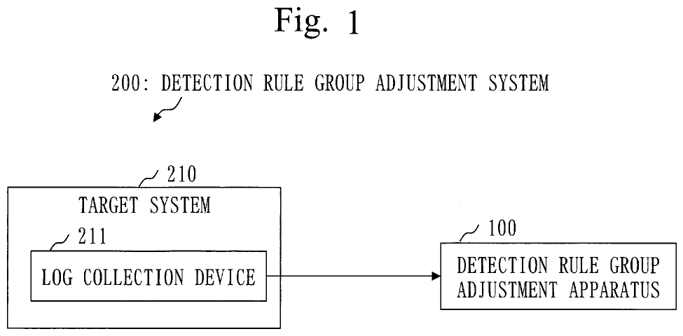

A detection rule group adjustment system 200 will be described based on FIG. 1 to FIG. 14.

***Description of Configuration***

A configuration of the detection rule group adjustment system 200 will be described based on FIG. 1.

The detection rule group adjustment system 200 includes a target system 210 and a detection rule group adjustment apparatus 100.

The target system 210 and the detection rule group adjustment apparatus 100 perform communication with each other via a network.

The target system 210 is a computer system that is to be a target of attack monitoring.

The target system 210 includes a log collection device 211.

The log collection device 211 collects a system log of the target system 210. That is, the log collection device 211 records the system log of the target system 210.

The system log indicates information of an event that occurred in the target system 210. An example of the system log is a communication log and a terminal log. The communication log indicates information of communication performed in the target system 210. The terminal log indicates operation of a terminal included in the target system 210.

The detection rule group adjustment apparatus 100 adjusts using a system log of the target system 210 under normal conditions, a detection rule group used for attack detection.

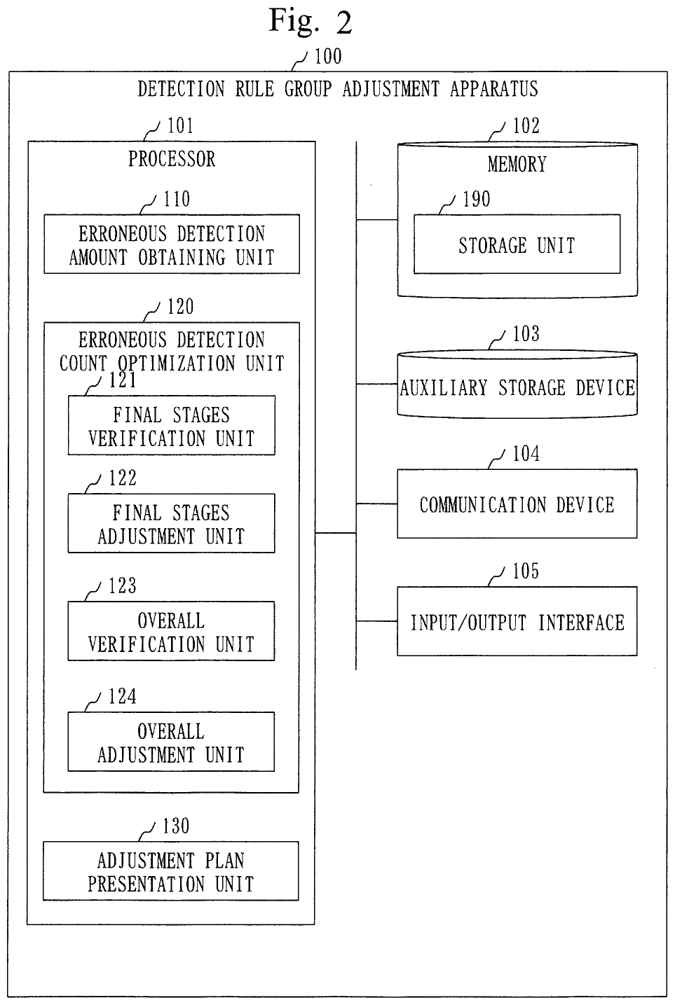

A configuration of the detection rule group adjustment apparatus 100 will be described based on FIG. 2.

The detection rule group adjustment apparatus 100 is a computer that includes hardware such as a processor 101, a memory 102, an auxiliary storage device 103, a communication device 104, and an input/output interface 105. These hardware are connected to each other via signal lines.

The processor 101 is an IC that performs a calculation process, and controls other hardware. For example, the processor 101 is a CPU, a DSP, or a GPU.

IC is an abbreviated name for Integrated Circuit.

CPU is an abbreviated name for Central Processing Unit.

DSP is an abbreviated name for Digital Signal Processor.

GPU is an abbreviated name for Graphics Processing Unit.

The memory 102 is a volatile storage device. The memory 102 is also called a main storage device or a main memory. For example, the memory 102 is a RAM. Data stored in the memory 102 is saved in the auxiliary storage device 103 as necessary.

RAM is an abbreviated name for Random Access Memory.

The auxiliary storage device 103 is a non-volatile storage device. For example, the auxiliary storage device 103 is a ROM, an HDD, or a flash memory. Data stored in the auxiliary storage device 103 is loaded into the memory 102 as necessary.

ROM is an abbreviated name for Read Only Memory.

HDD is an abbreviated name for Hard Disk Drive.

The communication device 104 is a receiver and a transmitter. For example, the communication device 104 is a communication chip or an NIC.

NIC is an abbreviated name for Network Interface Card.

The input/output interface 105 is a port to which an input device and an output device are connected. For example, the input/output interface 105 is a USB terminal, the input device is a keyboard and a mouse, and the output device is a display.

USB is an abbreviated name for Universal Serial Bus.

The detection rule group adjustment apparatus 100 includes elements such as an erroneous detection amount obtaining unit 110, an erroneous detection count optimization unit 120, and an adjustment plan presentation unit 130. These elements are realized by software.

The erroneous detection count optimization unit 120 includes a final stages verification unit 121, a final stages adjustment unit 122, an overall verification unit 123, and an overall adjustment unit 124.

A detection rule group adjustment program that makes a computer function as the erroneous detection amount obtaining unit 110, the erroneous detection count optimization unit 120, and the adjustment plan presentation unit 130 is stored in the auxiliary storage device 103. The detection rule group adjustment program is loaded into the memory 102 and executed by the processor 101.

An OS is, furthermore, stored in the auxiliary storage device 103. At least a part of the OS is loaded into the memory 102 and executed by the processor 101.

The processor 101 executes the detection rule group adjustment program while executing the OS.

OS is an abbreviated name for Operating System.

Inputted/outputted data of the detection rule group adjustment program is stored in a storage unit 190.

The memory 102 functions as the storage unit 190. A storage device such as the auxiliary storage device 103, a register in the processor 101, a cache memory in the processor 101, and the like, however, may function as the storage unit 190 instead of the memory 102 or with the memory 102.

The detection rule group adjustment apparatus 100 may include a plurality of processors that replace the processor 101. The plurality of processors share a role of the processor 101.

The detection rule group adjustment program can be computer-readably recorded (stored) in a non-volatile recording medium such as an optical disc, the flash memory, or the like.

***Description of Operation***

Operation of the detection rule group adjustment system 200 (especially the detection rule group adjustment apparatus 100) is equivalent to a detection rule group adjustment method. A procedure of the detection rule group adjustment method is equivalent to a procedure of the detection rule group adjustment program.

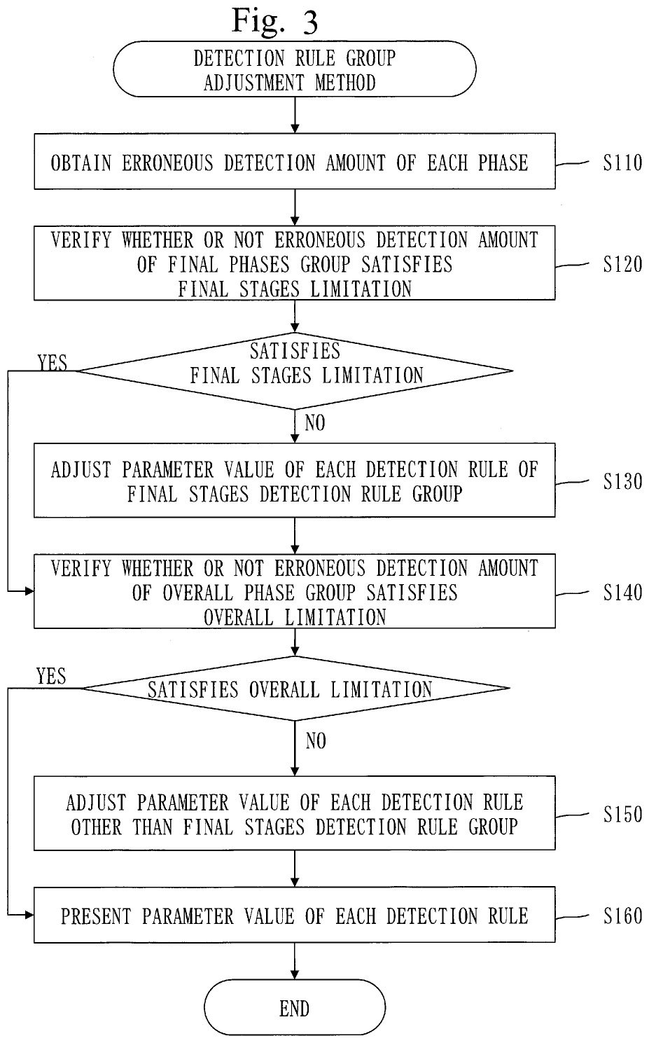

The detection rule group adjustment method will be described based on FIG. 3.

A plurality of attack phases that configure a series of attack activities are called “overall phase group”.

A detection rule group that corresponds to the overall phase group is called “overall detection rule group”. The overall detection rule group is a plurality of detection rules that correspond to the plurality of attack phases.

In step S110, the erroneous detection amount obtaining unit 110 obtains an erroneous detection amount of each phase of when the attack detection is performed using the overall detection rule group.

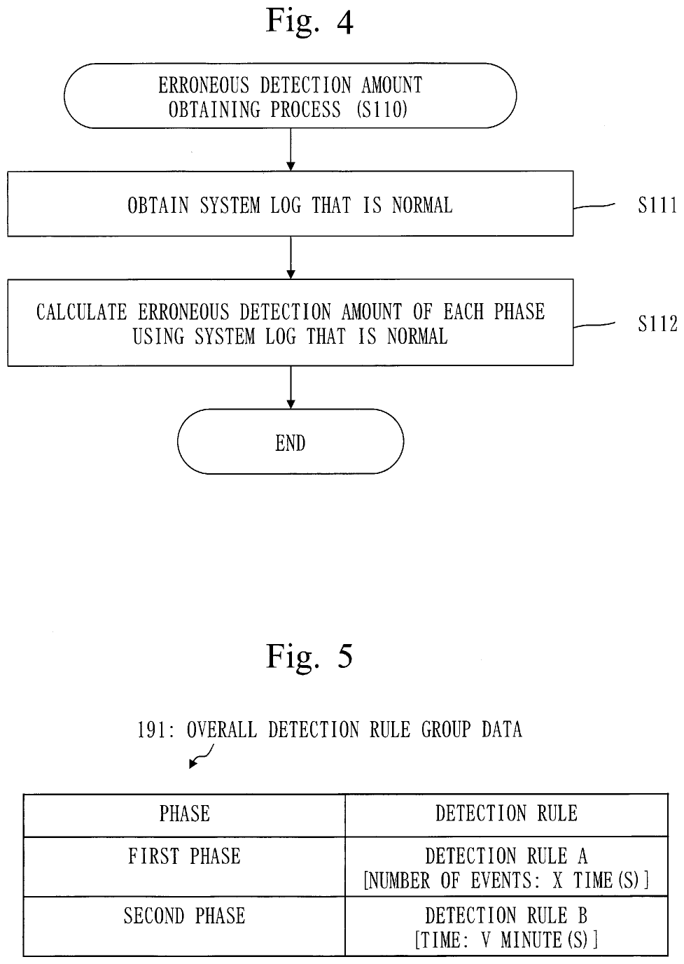

A procedure of an erroneous detection amount obtaining process (S110) will be described based on FIG. 4.

In step S111, the log collection device 211 collects a system log of the target system 210 that is normal.

Then, the erroneous detection amount obtaining unit 110 obtains the system log that is normal by communicating with the target system 210.

The system log that is normal is a plurality of pieces of log data that are produced while the target system 210 is not receiving an attack.

In step S112, the erroneous detection amount obtaining unit 110 calculates for each detection rule of the overall detection rule group, an erroneous detection count of the detection rule using the system log that is normal. The erroneous detection count of the detection rule is handled as an erroneous detection amount of a phase that corresponds to the detection rule.

The erroneous detection count of the detection rule is the count of pieces of log data that match the detection rule, and can be calculated by a conventional attack detection tool.

A specific example of overall detection rule group data 191 is illustrated in FIG. 5.

The overall detection rule group data 191 is data that indicates the overall detection rule group, and is stored in the storage unit 190 in advance.

For example, the overall phase group is a first phase and a second phase. And, the overall detection rule group is detection rule A that corresponds to the first phase and detection rule B that corresponds to the second phase.

Each detection rule has a parameter value. The parameter value is used as a threshold. For example, detection rule A has a parameter called the number of events, and a threshold of the number of events for detection rule A is “X time(s)”. Detection rule B has a parameter called time, and a threshold of the time for detection rule B is “V minute(s)”. The threshold “X time(s)” and the threshold “V minute(s)” are initial values.

Returning to FIG. 3, the description will continue from step S120.

In step S120, the final stages verification unit 121 verifies based on an erroneous detection amount of each phase of a final phases group in the overall phase group, whether or not an erroneous detection amount of the final phases group satisfies a final stages limitation.

The final phases group is one or more phases in final stages including a last phase. Assume that the final phases group is determined in advance.

The final stages limitation is a limitation on the erroneous detection amount of the final phases group.

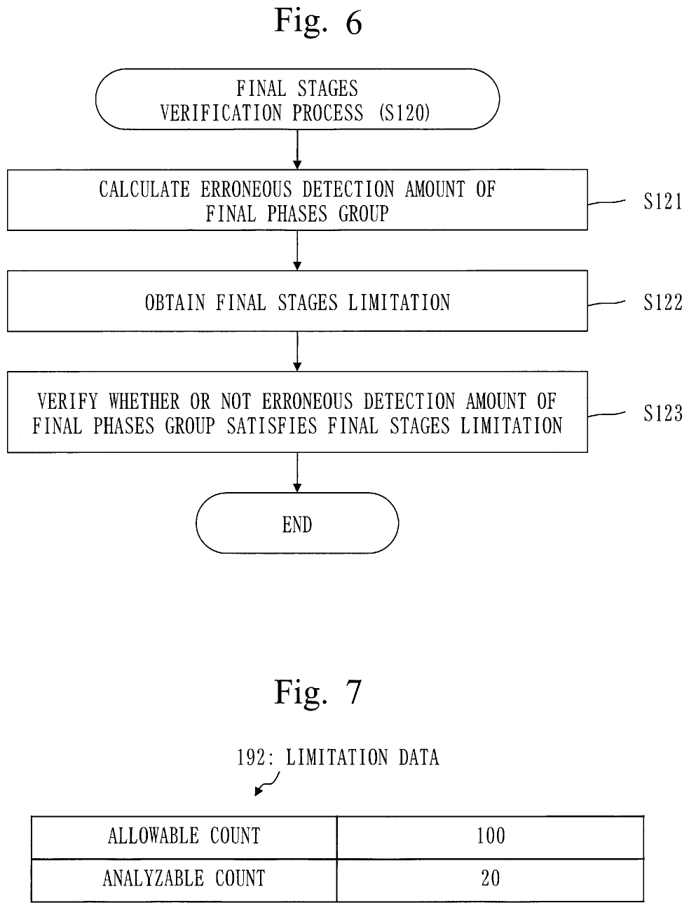

A procedure of a final stages verification process (S120) will be described based on FIG. 6.

In step S121, the final stages verification unit 121 extracts an erroneous detection amount of each phase of the final phases group from an erroneous detection amount of each phase of the overall phase group.

Then, the final stages verification unit 121 adds up the erroneous detection amount of each phase of the final phases group. A total that is calculated is the erroneous detection amount of the final phases group.

For example in FIG. 5, the second phase is the final phases group. In this case, an erroneous detection amount of the second phase becomes the erroneous detection amount of the final phases group.

In step S122, the final stages adjustment unit 122 obtains the final stages limitation from limitation data 192.

A specific example of the limitation data 192 is illustrated in FIG. 7.

The limitation data 192 is data indicating an overall limitation and the final stages limitation, and is stored in the storage unit 190 in advance.

The overall limitation is a limitation on the erroneous detection amount of the overall phase group and the final stages limitation is a limitation on the erroneous detection amount of the final phases group.

An allowable count “100” is the overall limitation. The allowable count “100” means that a maximum for the erroneous detection amount that is allowed in the overall phase group is “100”.

An analyzable count “20” is the final stages limitation. The analyzable count “20” means that a maximum for an erroneous detection amount that is analyzable in the final phases group is “20”.

Returning to FIG. 6, step S123 will be described.

In step S123, the final stages verification unit 121 verifies whether or not the erroneous detection amount of the final phases group satisfies the final stages limitation.

For example, assume that the second phase is in the final phases group, and the final stages limitation is the analyzable count “20” (refer to FIG. 5 and FIG. 7). In this case, the final stages verification unit 121 compares the erroneous detection amount of the second phase with the analyzable count “20”. In a case where the erroneous detection amount of the second phase is equal to or less than the analyzable count “20”, the final stages verification unit 121 verifies that the erroneous detection amount of the final phases group satisfies the final stages limitation.

Returning to FIG. 3, the description of step S120 will continue.

In a case where the erroneous detection amount of the final phases group satisfies the final stages limitation, the process proceeds to step S140.

In a case where the erroneous detection amount of the final phases group does not satisfy the final stages limitation, the process proceeds to step S130.

In step S130, the final stages adjustment unit 122 adjusts a parameter value of each detection rule of a final stages detection rule group in the overall detection rule group.

The final stages detection rule group is one or more detection rules that correspond to the final phases group.

A procedure of a final stages adjustment process (S130) will be described based on FIG. 8.

In step S131, the final stages adjustment unit 122 changes the parameter value of each detection rule of the final stages detection rule group.

Specifically, the final stages adjustment unit 122 changes the parameter value of each detection rule according to an adjustment rule.

The final stages adjustment unit 122 may change the parameter value of each of some of the detection rules or may change the parameter value of each of every detection rule.

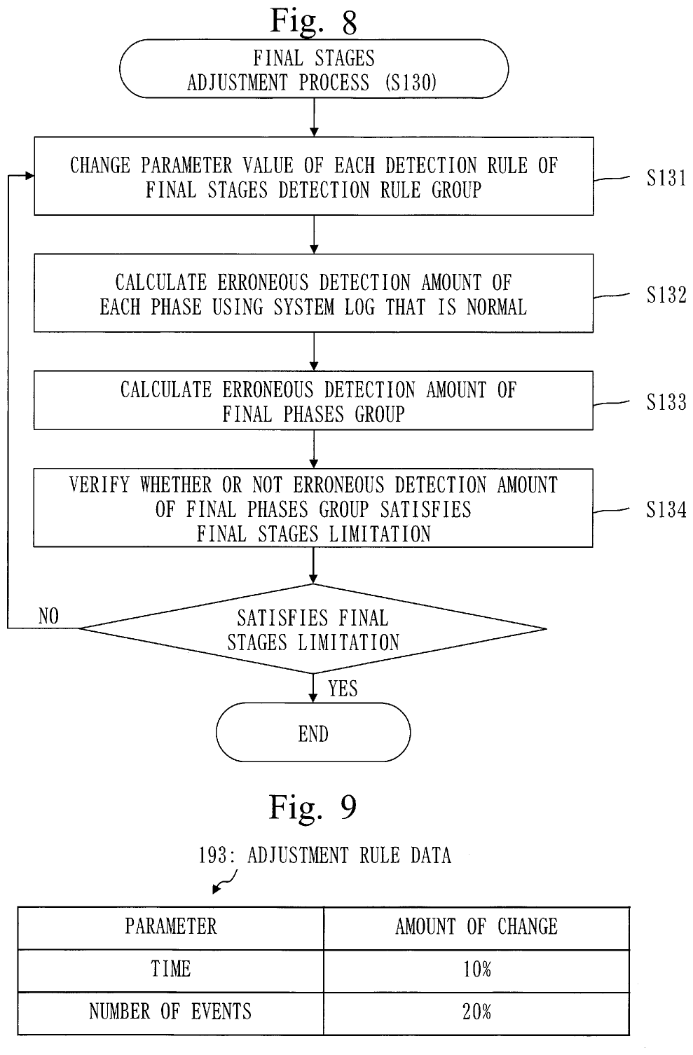

A specific example of adjustment rule data 193 will be illustrated in FIG. 9.

The adjustment rule data 193 is data that indicates an adjustment rule of a parameter value, and is stored in the storage unit 190 in advance.

Specifically, the adjustment rule data 193 indicates an amount of change of a parameter value for each type of parameter. For example, an amount of change of a parameter “time” is “10%”, and an amount of change of a parameter “the number of events” is “20%”. “%” means percent.

For example, the final stages adjustment unit 122 changes each detection rule of the final stages detection rule group as follows.

The final phases group is the second phase, and the final stages detection rule group is detection rule B (refer to FIG. 5). In detection rule B, a value of the parameter “time” is “V minute(s)”. The amount of change of the parameter “time” is “10%” (refer to FIG. 9).

In this case, the final stages adjustment unit 122 changes the parameter value of detection rule B, “V minute(s)”, to “(0.9×V) minute(s)”. “(0.9×V) minute(s)” is time where “V minute(s)” is made to be reduced by 10 percent.

Returning to FIG. 8, the description of step S131 will continue.

The final stages adjustment unit 122 records a parameter value of each detection rule after being changed.

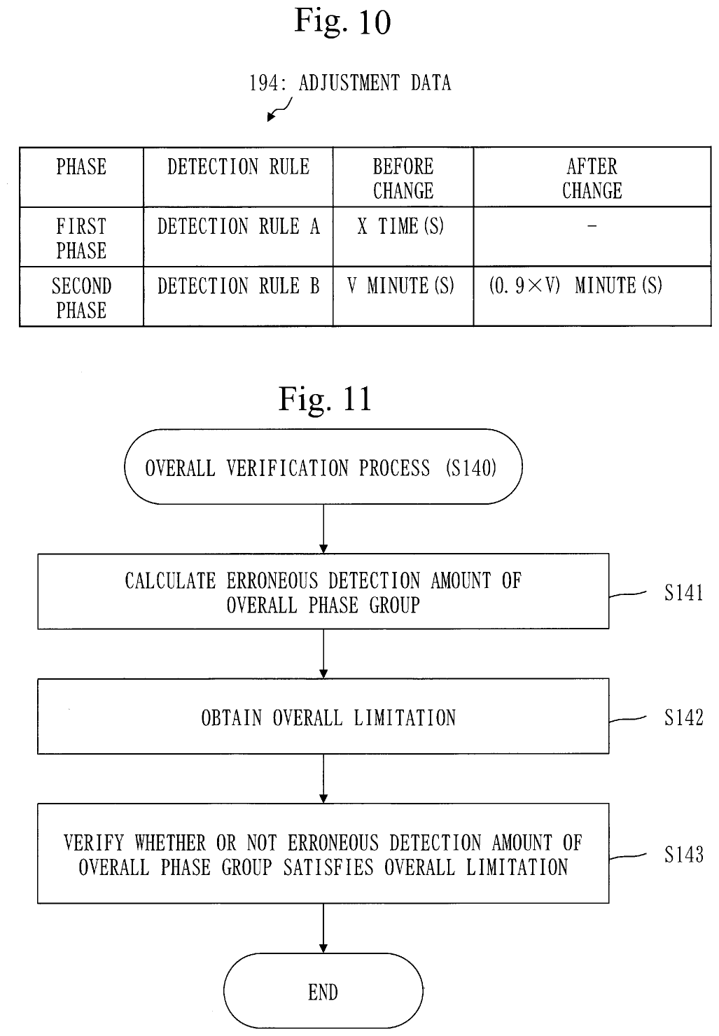

A specific example of adjustment data 194 is illustrated in FIG. 10.

The adjustment data 194 is data that indicates the parameter value of each detection rule after being changed, and is stored in the storage unit 190 in advance. The adjustment data 194 has a “phase” column, a “detection rule” column, a “before change” column, and an “after change” column. These columns correspond to each other.

The “phase” column specifies phases.

The “detection rule” column specifies detection rules.

The “before change” column indicates parameter values before being changed. Specifically, the “before change” column indicates initial parameter values or current parameter values.

The “after change” column indicates parameter values after being changed.

In a case where the parameter value of detection rule B is changed from “V minute(s)” to “(0.9×V) minute(s)”, the final stages adjustment unit 122 registers “(0.9×V) minute(s)” to the “after change” column corresponding to detection rule B.

Returning to FIG. 8, the description will continue from step S132.

In step S132, the erroneous detection amount obtaining unit 110 calculates the erroneous detection amount of each phase of the final phases group using the system log that is normal. The calculation method is the same as the method in step S112 (refer to FIG. 4).

In step S133, the final stages verification unit 121 calculates the erroneous detection amount of the final phases group. The calculation method is the same as the method in step S121 (refer to FIG. 6).

In step S134, the final stages verification unit 121 verifies whether or not the erroneous detection amount of the final phases group satisfies the final stages limitation. The verification method is the same as the method in step S123 (refer to FIG. 6).

In a case where the erroneous detection amount of the final phases group satisfies the final stages limitation, the final stages adjustment process (S130) ends.

In a case where the erroneous detection amount of the final phases group does not satisfy the final stages limitation, the process proceeds to step S131.

Returning to FIG. 3, the description will continue from step S140.

In step S140, the overall verification unit 123 verifies whether or not the erroneous detection amount of the overall phase group satisfies the overall limitation based on the erroneous detection amount of each phase of the overall phase group.

A procedure of an overall verification process (S140) will be described based on FIG. 11.

In step S141, the overall verification unit 123 adds up the erroneous detection amount of each phase of the overall phase group. A total that is calculated is the erroneous detection amount of the overall phase group.

In a case where the parameter value of each detection rule of the final stages detection rule group is adjusted, the erroneous detection amount of each phase of the final phases group is an erroneous detection amount after being adjusted.

In step S142, the overall verification unit 123 obtains the overall limitation from the limitation data 192.

In step S143, the overall verification unit 123 verifies whether or not the erroneous detection amount of the overall phase group satisfies the overall limitation.

For example, assume that the first phase and the second phase are the overall phase group, and the overall limitation is the allowable count “100” (refer to FIG. 5 and FIG. 7). In this case, the overall verification unit 123 compares the erroneous detection amount of the overall phase group with the allowable count “100”. In a case where the erroneous detection amount of the overall phase group is equal to or less than the allowable count “100”, the overall verification unit 123 verifies that the erroneous detection amount of the overall phase group satisfies the overall limitation.

Returning to FIG. 3, the description of step S140 will continue.

In a case where the erroneous detection amount of the overall phase group satisfies the overall limitation, the process proceeds to step S160.

In a case where the erroneous detection amount of the overall phase group does not satisfy the overall limitation, the process proceeds to step S150.

In step S150, the overall adjustment unit 124 adjusts a parameter value of each detection rule other than the final stages detection rule group in the overall detection rule group.

A procedure of an overall adjustment process (S150) will be described based on FIG. 12.

In step S151, the overall adjustment unit 124 changes the parameter value of each detection rule other than the final stages detection rule group. The change method is the same as the method in step S131 (refer to FIG. 8).

The overall adjustment unit 124 may change the parameter value of each of some of the detection rules or may change the parameter value of each of every detection rule.

For example, the overall adjustment unit 124 changes each detection rule other than the final stages detection rule group as follows.

A phase other than the final phases group is the second phase, and the detection rule other than the final stages detection rule group is detection rule A (refer to FIG. 5). The parameter of detection rule A is “the number of events”, and the parameter value of detection rule A is “X time(s)”. The amount of change of the parameter “the number of events” is “20%” (refer to FIG. 9).

In this case, the overall adjustment unit 124 changes the parameter value of detection rule A, “X time(s)”, to “(0.8×X) time(s)”. “(0.8×X) time(s)” is the number of times where “X time(s)” is made to be reduced by 20 percent.

The description of step S151 will continue.

The overall adjustment unit 124 records the parameter value of each detection rule after being changed.

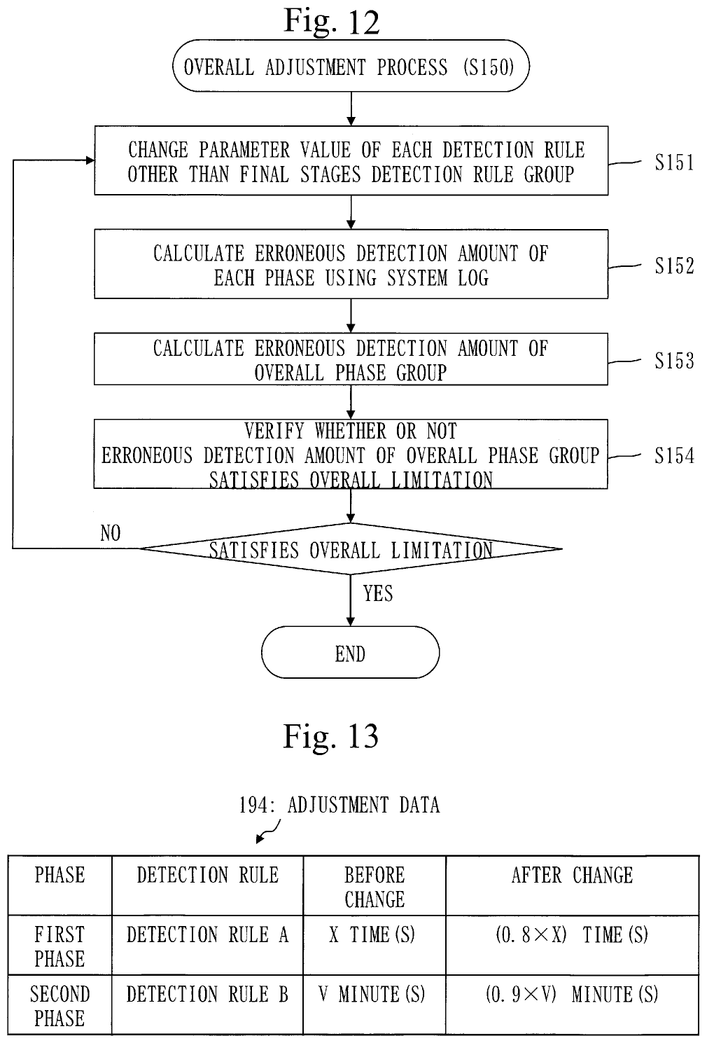

A specific example of the adjustment data 194 is illustrated in FIG. 13. In a case where the parameter value of detection rule A is changed from “X time(s)” to “(0.8×X) time(s)”, the overall adjustment unit 124 registers “(0.8×X) time(s)” in the “after change” column corresponding to detection rule A.

Returning to FIG. 12, the description will continue from step S152.

In step S152, the erroneous detection amount obtaining unit 110 calculates the erroneous detection amount of each phase of the overall phase group using the system log that is normal. The calculation method is the same as the method in step S112 (refer to FIG. 4).

In step S153, the overall verification unit 123 calculates the erroneous detection amount of the overall phase group. The calculation method is the same as the method in step S141 (refer to FIG. 11).

In step S154, the overall verification unit 123 verifies whether or not the erroneous detection amount of the overall phase group satisfies the overall limitation. The verification method is the same as the method in step S143 (refer to FIG. 11).

In a case where the erroneous detection amount of the overall phase group satisfies the overall limitation, the overall adjustment process (S150) ends.

In a case where the erroneous detection amount of the overall phase group does not satisfy the overall limitation, the process proceeds to step S151.

Returning to FIG. 3, step S160 will be described.

In step S160, the adjustment plan presentation unit 130 presents the parameter value of each detection rule of the overall detection rule group.

Specifically, the adjustment plan presentation unit 130 displays the parameter value of each detection rule of the overall detection rule group on a display. The adjustment plan presentation unit 130, however, may perform presentation by a method other than displaying (saving in a recording medium, sending to the outside, printing by a printer, and the like).

For example, the adjustment plan presentation unit 130 displays the adjustment data 194 (refer to FIG. 13) on a display.

### Description of Embodiment

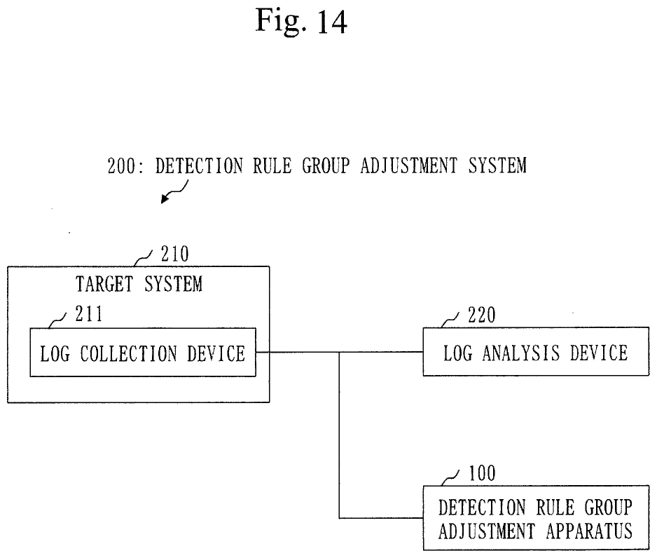

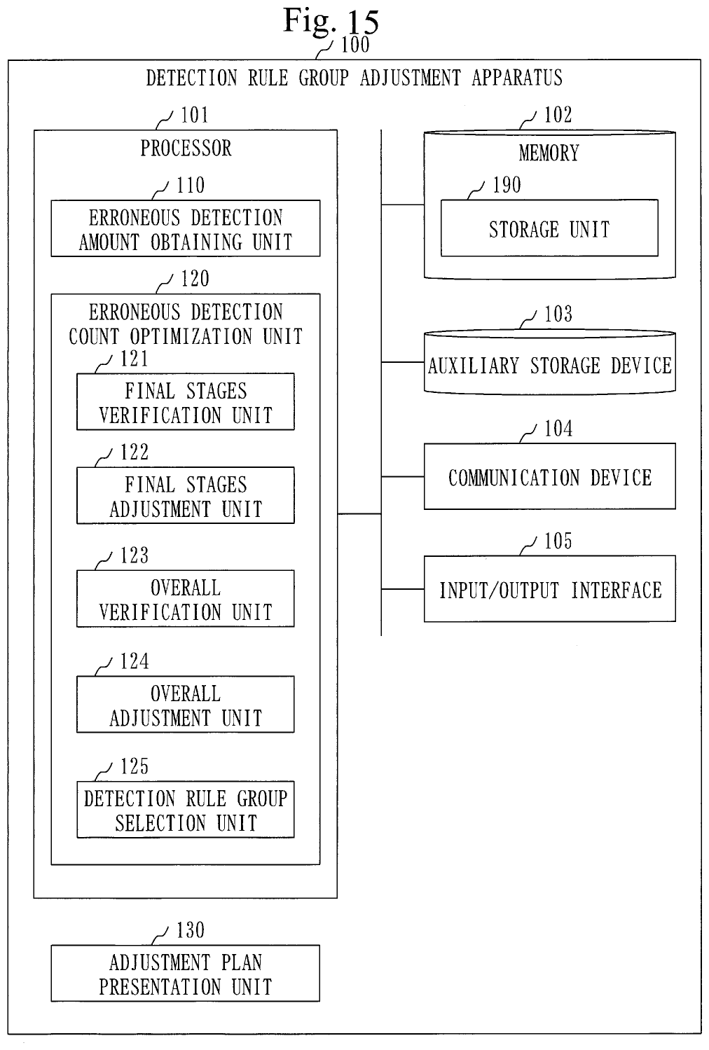

A configuration example of the detection rule group adjustment system 200 is illustrated in FIG. 14.

The detection rule group adjustment system 200 includes a log analysis device 220 in addition to the target system 210 and the detection rule group adjustment apparatus 100.

The log analysis device 220 is a computer that analyzes the system log.

The log analysis device 220 calculates the erroneous detection amount of each phase in place of the erroneous detection amount obtaining unit 110.

The erroneous detection amount obtaining unit 110 obtains the erroneous detection amount of each phase by communicating with the log analysis device 220.

### Effect of Embodiment 1

In Embodiment 1, in addition to an allowable count of erroneous detection for all of the monitors, a place to be adjusted in the overall detection rule group is specified using an erroneous detection count that an analyst is able to respond to in the final phases.

That is, an adjustment of a threshold for each detection rule is performed using the allowable count of all of the monitors and an analyzable count of the analyst. As a result, the final stages detection rule group and a detection rule group other than the final stages detection rule group can be adjusted using only a system log that is normal.

### Embodiment 2

With regard to a mode of prevention of an omission of detection, mainly points that differ from Embodiment 1 will be described based on FIG. 15 to FIG. 23.

***Description of Configuration***

A configuration of a detection rule group adjustment system 200 is the same as the configuration in Embodiment 1 (refer to FIG. 1 and FIG. 14).

A configuration of a detection rule group adjustment apparatus 100 will be described based on FIG. 15.

An erroneous detection count optimization unit 120 further includes a detection rule group selection unit 125.

Other configurations are the same as the configurations in Embodiment 1 (refer to FIG. 2).

***Description of Operation***

The detection rule group adjustment apparatus 100 will be described based on

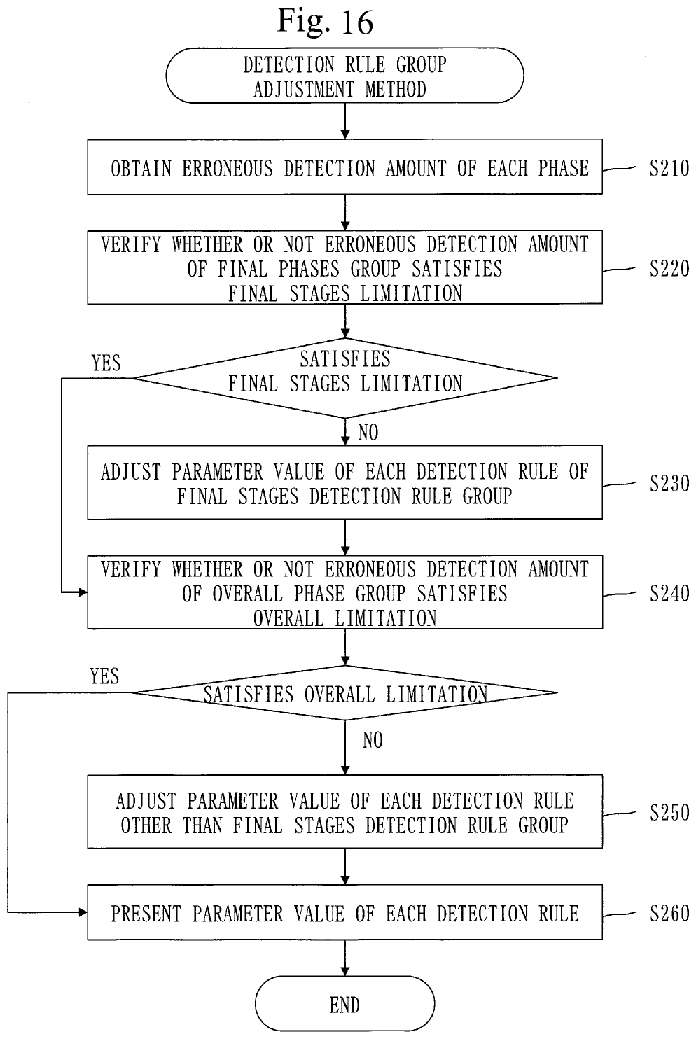

FIG. 16.

In step S210, the erroneous detection amount obtaining unit 110 obtains an erroneous detection amount of each phase of when attack detection is performed using the overall detection rule group.

Step S210 is the same as step S110 in Embodiment 1 (refer to FIG. 3).

In step S220, the final stages verification unit 121, based on the erroneous detection amount of each phase of the final phases group in the overall phase group, verifies whether or not the erroneous detection amount of the final phases group satisfies the final stages limitation.

Step S220 is the same as step S120 in Embodiment 1 (refer to FIG. 3).

In a case where the erroneous detection amount of the final phases group satisfies the final stages limitation, the process proceeds to step S240.

In a case where the erroneous detection amount of the final phases group does not satisfy the final stages limitation, the process proceeds to step S230.

In step S230, the final stages adjustment unit 122 adjusts a parameter value of each detection rule of the final stages detection rule group by a plurality of patterns. As a result, a plurality of final stages detection rule groups are generated. The plurality of final stages detection rule groups differ from each other in combinations of parameter values.

The erroneous detection amount obtaining unit 110 obtains, for each final stages detection rule group, the erroneous detection amount of when attack detection is performed using the final stages detection rule group.

The detection rule group selection unit 125 selects a final stages detection rule group that satisfies the final stages limitation.

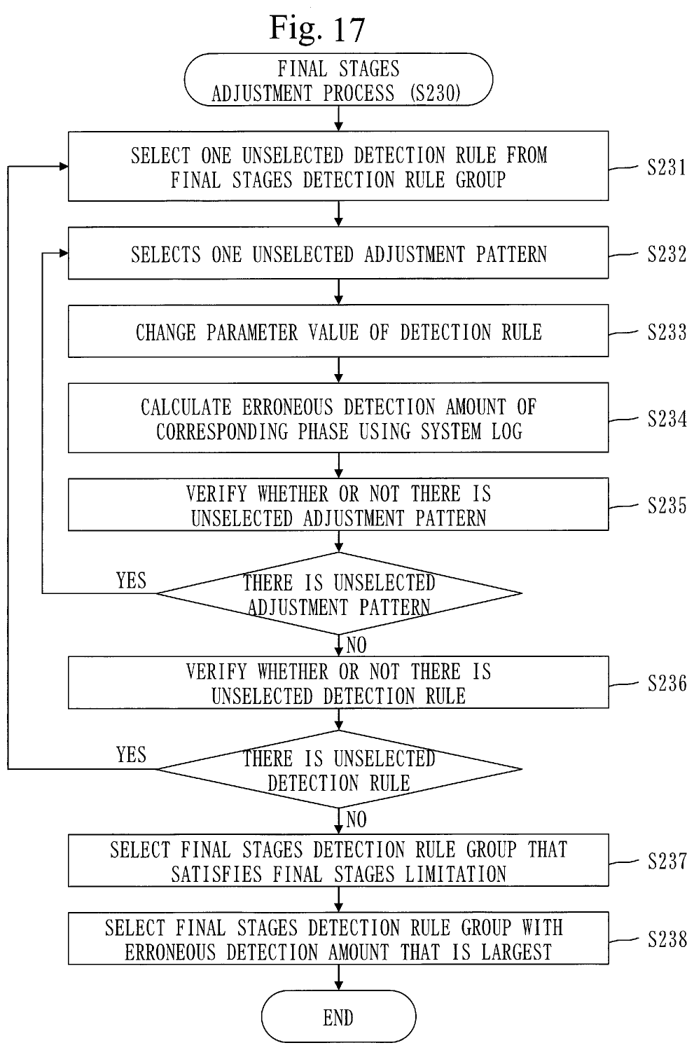

A procedure of a final stages adjustment process (S230) will be described based on FIG. 17.

In step S231, the final stages adjustment unit 122 selects one unselected detection rule from the final stages detection rule group.

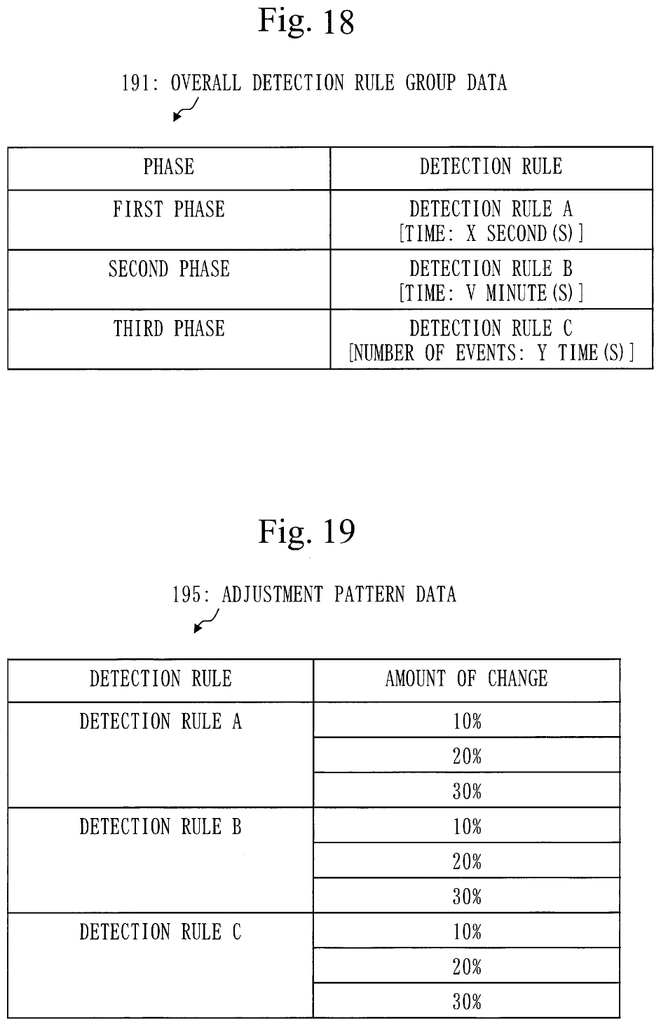

A specific example of overall detection rule group data 191 is illustrated in FIG. 18.

The overall detection rule group data 191 indicates the overall detection rule group that corresponds to the overall phase group, the overall phase group having a first phase to a third phase.

A detection rule that corresponds to the first phase is detection rule A. Detection rule A has a parameter called time, and a threshold of the time for detection rule A is “X second(s)”.

A detection rule that corresponds to the second phase is detection rule B. Detection rule B has a parameter called time, and a threshold of the time for detection rule B is “V minute(s)”.

A detection rule that corresponds to the third phase is detection rule C. Detection rule C has a parameter called the number of events, and a threshold of the number of events for detection rule C is “Y time(s)”.

The final phases group is the third phase.

The final stages adjustment unit 122 selects detection rule C that corresponds to the third phase.

Returning to FIG. 17, the description will continue from step S232.

In step S232, the final stages adjustment unit 122 selects one unselected adjustment pattern from a plurality of adjustment patterns.

A specific example of adjustment pattern data 195 is illustrated in FIG. 19.

The adjustment pattern data 195 is data that indicates the plurality of adjustment patterns, and is stored in the storage unit 190 in advance.

Specifically, the adjustment pattern data 195 indicates a plurality of amounts of change of the parameter value for every detection rule.

The final stages adjustment unit 122 selects one unselected amount of change from three amounts of change (10%, 20%, 30%) of detection rule C, detection rule C corresponding to the third phase (the final phases group).

Returning to FIG. 17, the description will continue from step S233.

In step S233, the final stages adjustment unit 122 changes a parameter value of the detection rule selected according to the adjustment pattern selected.

For example, the parameter value of detection rule C is “Y time(s)”, and an amount of adjustment of detection rule C is “10%”. In this case, the final stages adjustment unit 122 changes the parameter value of detection rule C, “Y time(s)”, to “(0.9×Y) time(s)”. “(0.9×Y) time(s)” is the number of times where “Y time(s)” is made to be reduced by 10 percent.

In step S234, the erroneous detection amount obtaining unit 110 calculates an erroneous detection amount of the detection rule selected using the system log that is normal. The erroneous detection amount of the detection rule is handled as the erroneous detection amount of the phase corresponding to the detection rule.

In the erroneous detection amount of the detection rule, an erroneous detection count of the detection rule and an erroneous detection rate of the detection rule are included. The erroneous detection count of the detection rule is the number of pieces of log data that match the detection rule. The erroneous detection rate of the detection rule is a percentage of the log data that matches the detection rule. The erroneous detection amount of the detection rule can be calculated by a conventional attack detection tool.

In step S235, the final stages adjustment unit 122 verifies whether or not there is an unselected adjustment pattern.

In a case where there is an unselected adjustment pattern, the process proceeds to step S232.

In a case where there is no unselected adjustment pattern, the process proceeds to step S236.

In step S236, the final stages adjustment unit 122 verifies whether or not there is an unselected detection rule.

In a case where there is an unselected detection rule, the process proceeds to step S231.

In a case where there is no unselected detection rule, the process proceeds to step S237.

Through the processes from step S231 to step S236, the plurality of final stages detection rule groups that differ from each other in combinations of parameter values can be obtained.

In step S237, the erroneous detection amount obtaining unit 110 calculates the erroneous detection amount of the final phases group for each final stages detection rule group.

An erroneous detection count of the final phases group and an erroneous detection rate of the final phases group are included in the erroneous detection amount of the final phases group.

The erroneous detection count of the final phases group is a value of which the erroneous detection count of each phase of the final phases group are added up.

The erroneous detection rate of the final phases group is a representative value of the erroneous detection rate in the final phases group. A specific example of the representative value is a minimum value, a maximum value, a mean value, or a total value.

The final stages verification unit 121 verifies, for each final stages detection rule, whether or not the erroneous detection amount of the final phases group satisfies the final stages limitation. The verification method is the same as the method of step S123 in Embodiment 1 (refer to FIG. 6).

The detection rule group selection unit 125 selects from the plurality of final stages detection rule groups, the final stages detection rule group that satisfies the final stages limitation.

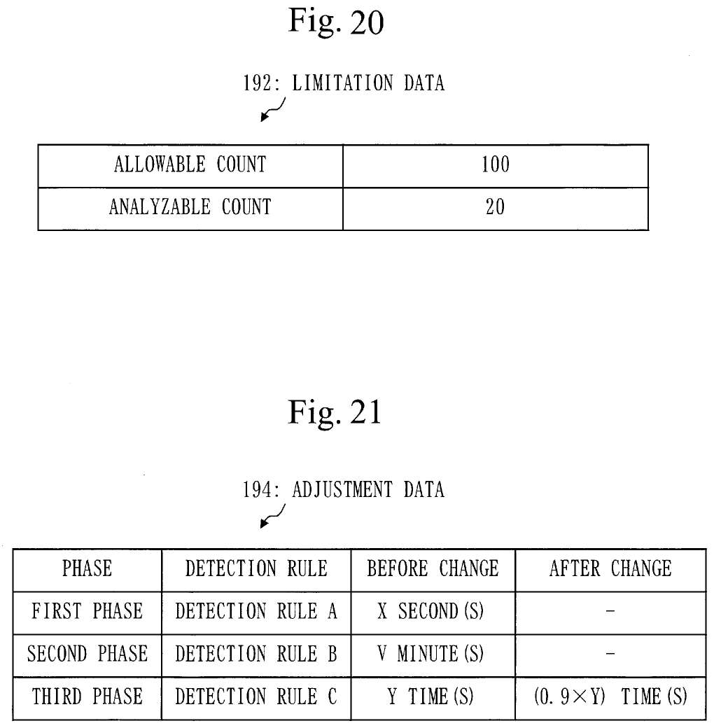

A specific example of limitation data 192 is illustrated in FIG. 20.

An allowable count “100” is an overall limitation. That is, a maximum for the erroneous detection amount allowed in the overall phase group is “100”, the overall phase group having the first phase to the third phase.

An analyzable count “20” is the final stages limitation. That is, a maximum of an erroneous detection amount that is analyzable in the third phase, the third phase being the final phases group, is “20”.

Returning to FIG. 17, step S238 will be described.

In step S238, the detection rule group selection unit 125 selects from the final stages detection rule groups selected in step S237, the final stages detection rule group with the erroneous detection amount that is largest.

Specifically, the detection rule group selection unit 125 selects the final stages detection rule group with the erroneous detection rate that is highest.

Then, the detection rule group selection unit 125 records the parameter value of each detection rule of the final stages detection rule group selected.

A specific example of adjustment data 194 is illustrated in FIG. 21.

In a case where detection rule C of which the parameter value is changed to (0.9×Y) time(s) is selected, the detection rule group selection unit 125 registers “(0.9×Y) time(s)” in an “after change” column corresponding to detection rule C.

Returning to FIG. 16, the description will continue from step S240.

In step S240, the overall verification unit 123 verifies whether or not an erroneous detection amount of the overall phase group satisfies the overall limitation based on the erroneous detection amount of each phase of the overall phase group. The verification method is the same as the method in step S140 of Embodiment 1 (refer to FIG. 3).

In a case where the erroneous detection amount of the overall phase group satisfies the overall limitation, the process proceeds to step S260.

In a case where the erroneous detection amount of the overall phase group does not satisfy the overall limitation, the process proceeds to step S250.

In step S250, the overall adjustment unit 124 adjusts a parameter value of each detection rule other than the final stages detection rule group in the overall detection rule group by a plurality of patterns. As a result, a plurality of overall detection rule groups are generated. The plurality of overall detection rule groups differ from each other in combinations of parameter values.

The erroneous detection amount obtaining unit 110 obtains, for each overall detection rule group, an erroneous detection amount of when attack detection is performed using the overall detection rule group.

The detection rule group selection unit 125 selects an overall detection rule group from the plurality of overall detection rule groups based on the erroneous detection amount of each overall detection rule group.

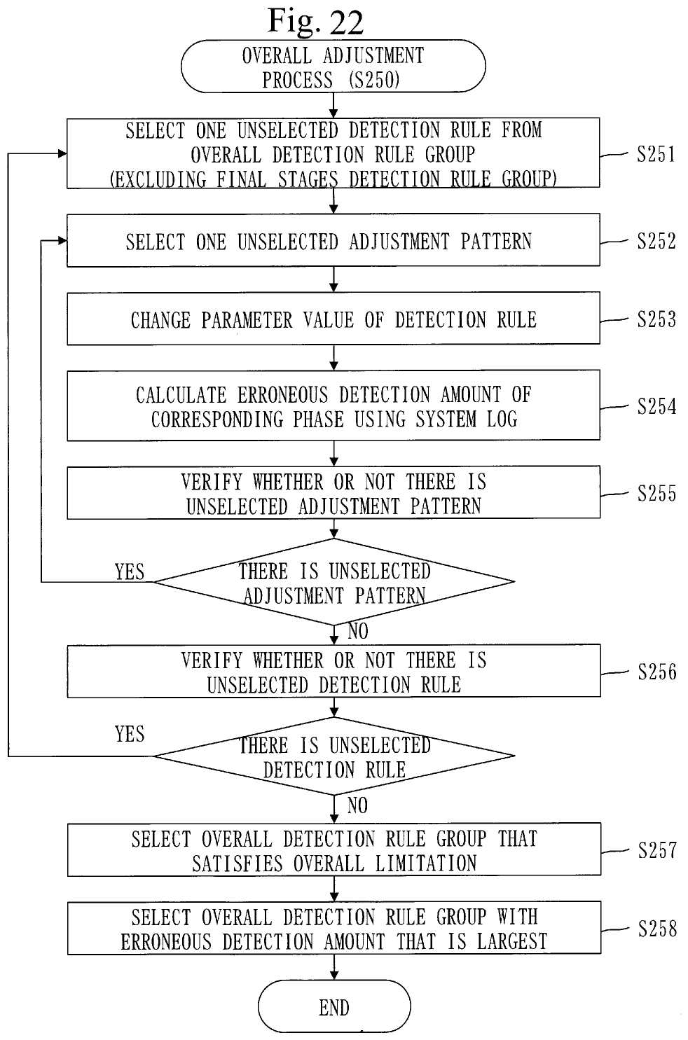

A procedure of an overall adjustment process (S250) will be described based on FIG. 22.

In step S251, the overall adjustment unit 124 selects one unselected detection rule from the overall detection rule group excluding the final stages detection rule group.

For example, detection rule A, detection rule B, and detection rule C are the overall detection rule group, and detection rule C is the final stages detection rule group (refer to FIG. 18). In this case, the overall adjustment unit 124 selects one unselected detection rule from either one of detection rule A and detection rule B.

In step S252, the overall adjustment unit 124 selects one unselected adjustment pattern from the plurality of adjustment patterns.

For example, the detection rule selected in step S251 is detection rule A. In this case, the overall adjustment unit 124 selects one unselected amount of change from three amounts of change (10%, 20%, 30%) of detection rule A (refer to FIG. 19).

In step S253, the overall adjustment unit 124 changes a parameter value of the detection rule selected according to the adjustment pattern selected.

For example, a parameter value of detection rule A is “X second(s)”, and an amount of adjustment of detection rule A is “10%”. In this case, the overall adjustment unit 124 changes the parameter value of detection rule A, “X second(s)”, to “(0.9×X) second(s)”. “(0.9×X) second(s)” is the number of seconds where “X second(s)” is made to be reduced by 10 percent.

In step S254, the erroneous detection amount obtaining unit 110 calculates using the system log that is normal, the erroneous detection amount of the detection rule selected. The erroneous detection amount of the detection rule is handled as the erroneous detection amount of the phase corresponding to the detection rule.

In the erroneous detection amount of the detection rule, the erroneous detection count of the detection rule and the erroneous detection rate of the detection rule are included. The erroneous detection count of the detection rule is the number of pieces of log data that match the detection rule. The erroneous detection rate of the detection rule is the percentage of the log data that matches the detection rule. The erroneous detection amount of the detection rule can be calculated by a conventional attack detection tool.

In step S255, the final stages adjustment unit 122 verifies whether or not there is an unselected adjustment pattern.

In a case where there is an unselected adjustment pattern, the process proceeds to step S252.

In a case where there is no unselected adjustment pattern, the process proceeds to step S256.

In step S256, the final stages adjustment unit 122 verifies whether or not there is an unselected detection rule.

In a case where there is an unselected detection rule, the process proceeds to step S251.

In a case where there is no unselected detection rule, the process proceeds to step S257.

Through the processes from step S251 to step S256, the plurality of overall detection rule groups that differ from each other in combinations of parameter values can be obtained.

In step S257, the erroneous detection amount obtaining unit 110 calculates the erroneous detection amount of the overall phase group for each overall detection rule group.

An erroneous detection count of the overall phase group and an erroneous detection rate of the overall phase group are included in the erroneous detection amount of the overall phase group.

The erroneous detection count of the overall phase group is a value of which the erroneous detection count of each phase of the overall phase group are added up.

The erroneous detection rate of the overall phase group is a representative value of the erroneous detection rate in the overall phase group. A specific example of the representative value is a minimum value, a maximum value, a mean value, or a total value.

The overall verification unit 123 verifies, for each overall detection rule, whether or not the erroneous detection amount of the overall phase group satisfies the overall limitation. The verification method is the same as the method of step S143 in Embodiment 1 (refer to FIG. 11).

The detection rule group selection unit 125 selects from the plurality of overall detection rule groups, the overall detection rule group that satisfies the overall limitation.

In step S258, the detection rule group selection unit 125 selects from the overall detection rule groups selected in step S257, the overall detection rule group with the erroneous detection amount that is largest.

Specifically, the detection rule group selection unit 125 selects the overall detection rule group with the erroneous detection rate that is highest.

Then, the detection rule group selection unit 125 records the parameter value of each detection rule of the overall detection rule group selected.

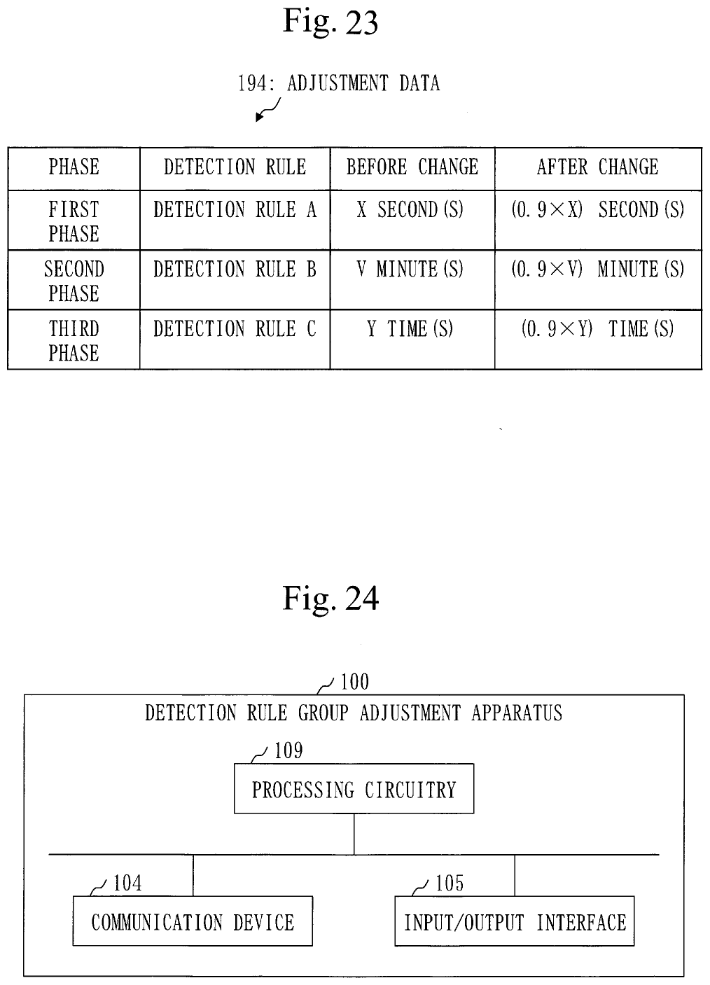

A specific example of the adjustment data 194 is illustrated in FIG. 23.

In the overall detection rule group selected, the parameter value of detection rule A is changed to (0.9×X) second(s), and the parameter value of detection rule B is changed to (0.9×V) minute(s). In this case, the detection rule group selection unit 125 registers “(0.9×X) second(s)” in the “after change” column corresponding to detection rule A. The detection rule group selection unit 125 registers “(0.9×V) minute(s)” in the “after change” column corresponding to detection rule B.

Returning FIG. 16, step S260 will be described.

In step S260, the adjustment plan presentation unit 130 presents the parameter value of each detection rule of the overall detection rule group selected in step S250. The presentation method is the same as the method in step S160 of Embodiment 1 (refer to FIG. 3).

For example, the adjustment plan presentation unit 130 displays the adjustment data 194 (refer to FIG. 23) on a display.

### Effect of Embodiment 2

In Embodiment 2, as a standard for adjusting each detection rule, an erroneous detection rate is also used. In a case where a detection rule group with a high erroneous detection rate is to be used, many of events that occur are detected being considered abnormal. Consequently, a possibility of an even that occurred by an attack being detected without omission is strong. That is, in a case where a detection rule group with a high erroneous detection rate is to be used, a detection rate of an attack is high and there is few omission of detection. Thus, at a time of performing an adjustment of a threshold in a way that an erroneous detection count is within an allowable range, an adjustment is performed on a threshold to be applied to a detection rule group with an erroneous detection rate that is highest in detection rule groups for detecting a series of attack activities.

That is, in addition to an allowable count for all of the monitors and an analyzable count of an analyst, the adjustment of the threshold is performed using the erroneous detection rate. As a result, even in a case where there are multiple detection rules to be responded to by an operator, the adjustment of the plurality of detection rules can be performed using only a system log that is normal.

### Supplement to Embodiments

A hardware configuration of the detection rule group adjustment apparatus 100 will be described based on FIG. 24.

The detection rule group adjustment apparatus 100 includes a processing circuitry 109.

The processing circuitry 109 is hardware that realizes the erroneous detection amount obtaining unit 110, the erroneous detection count optimization unit 120, and the adjustment plan presentation unit 130.

The processing circuitry 109 may be dedicated hardware, or may be the processing circuitry 109 that executes programs stored in the memory 102.

In a case where the processing circuitry 109 is dedicated hardware, the processing circuitry 109 is, for example, a single circuit, a composite circuit, a programmed processor, a parallel programmed processor, an ASIC, an FPGA, or a combination of these.

ASIC is an abbreviated name for Application Specific Integrated Circuit.

FPGA is an abbreviated name for Field Programmable Gate Array.

The detection rule group adjustment apparatus 100 may include a plurality of processing circuitries that replace the processing circuitry 109. The plurality of processing circuitries share a role of the processing circuitry 109.

In the processing circuitry 109, some of the functions may be realized by dedicated hardware and the rest of the functions may be realized by software or firmware.

As described, the processing circuitry 109 can be realized by hardware, software, firmware, or a combination of these.

The embodiments are examples of preferred modes, and are not intended to limit the technical scope of the present invention. The embodiments may be executed partially or may be executed being combined with other modes. The procedures described using the flowcharts and the like may be changed as appropriate.

The log collection device 211 may be replaced with “log collection unit”. The log analysis device 220 may be replaced with “log analysis unit”.

The detection rule group adjustment apparatus 100 may be realized by a plurality of devices.

“Unit”, which is an element of the detection rule group adjustment system 200, may be replaced with “process” or “step”.

### REFERENCE SIGNS LIST

100: detection rule group adjustment apparatus; 101: processor; 102: memory; 103: auxiliary storage device; 104: communication device; 105: input/output interface; 109: processing circuitry; 110: erroneous detection amount obtaining unit; 120: erroneous detection count optimization unit; 121: final stages verification unit; 122: final stages adjustment unit; 123: overall verification unit; 124: overall adjustment unit; 125: detection rule group selection unit; 130: adjustment plan presentation unit; 190: storage unit; 191: overall detection rule group data; 192: limitation data; 193: adjustment rule data; 194: adjustment data; 195: adjustment pattern data; 200: detection rule group adjustment system; 210: target system; 211: log collection device; 220: log analysis device.

1. A detection rule group adjustment apparatus comprising:
processing circuitry to:
obtain using an overall detection rule group corresponding to an overall phase group that configures a series of attack activities, an erroneous detection amount of each phase of when attack detection is performed,
verify based on an erroneous detection amount of each phase of a final phases group in the overall phase group, whether or not the erroneous detection amount of the final phases group satisfies a final stages limitation,
verify based on the erroneous detection amount of each phase of the overall phase group, whether or not the erroneous detection amount of the overall phase group satisfies an overall limitation,
in a case where the erroneous detection amount of the final phases group does not satisfy the final stages limitation, adjust a parameter value of each detection rule of a final stages detection rule group in the overall detection rule group, and
in a case where the erroneous detection amount of the final phases group satisfies the final stages limitation and the erroneous detection amount of the overall phase group does not satisfy the overall limitation, adjust a parameter value of each detection rule other than the final stages detection rule group in the overall detection rule group.

2. The detection rule group adjustment apparatus according to claim 1 comprising:
processing circuitry to:
in a case where the parameter value of each detection rule of the overall detection rule group is adjusted, present a parameter value of each detection rule after being adjusted.

3. The detection rule group adjustment apparatus according to claim 1 comprising:
processing circuitry,
wherein the processing circuitry
generates a plurality of overall detection rule groups by adjusting the parameter value of each detection rule other than the final stages detection rule group by a plurality of patterns,
obtains for each overall detection rule group, the erroneous detection amount of when the attack detection is performed using the overall detection rule group, and
selects the overall detection rule group from the plurality of overall detection rule groups based on the erroneous detection amount of each overall detection rule group.

4. The detection rule group adjustment apparatus according to claim 3,
wherein the processing circuitry
selects an overall detection rule group with the erroneous detection amount that is largest in overall detection rule groups that satisfy the overall limitation.

5. The detection rule group adjustment apparatus according to claim 3 comprising:
processing circuitry to:
present a parameter value of each detection rule of the overall detection rule group selected.

6. The detection rule group adjustment apparatus according to claim 1,
wherein the processing circuitry
using a plurality of pieces of log data that are produced while a target system is not receiving an attack, calculates a count of pieces of log data that match the detection rule as an erroneous detection amount of a phase corresponding to the detection rule.

7. The detection rule group adjustment apparatus according to claim 1,
wherein the processing circuitry
obtains the erroneous detection amount of each phase from a log analysis device, and
the log analysis device, using a plurality of pieces of log data that are produced while a target system is not receiving an attack, calculates a count of pieces of log data that match the detection rule as an erroneous detection amount of a phase corresponding to the detection rule.

8. The detection rule group adjustment apparatus according to claim 4 comprising:
processing circuitry to:
present a parameter value of each detection rule of the overall detection rule group selected.

9. The detection rule group adjustment apparatus according to claim 2,
wherein the processing circuitry
using a plurality of pieces of log data that are produced while a target system is not receiving an attack, calculates a count of pieces of log data that match the detection rule as an erroneous detection amount of a phase corresponding to the detection rule.

10. The detection rule group adjustment apparatus according to claim 3,
wherein the processing circuitry
using a plurality of pieces of log data that are produced while a target system is not receiving an attack, calculates a count of pieces of log data that match the detection rule as an erroneous detection amount of a phase corresponding to the detection rule.

11. The detection rule group adjustment apparatus according to claim 4,
wherein the processing circuitry
using a plurality of pieces of log data that are produced while a target system is not receiving an attack, calculates a count of pieces of log data that match the detection rule as an erroneous detection amount of a phase corresponding to the detection rule.

12. The detection rule group adjustment apparatus according to claim 5,
wherein the processing circuitry
using a plurality of pieces of log data that are produced while a target system is not receiving an attack, calculates a count of pieces of log data that match the detection rule as an erroneous detection amount of a phase corresponding to the detection rule.

13. The detection rule group adjustment apparatus according to claim 8,
wherein the processing circuitry
using a plurality of pieces of log data that are produced while a target system is not receiving an attack, calculates a count of pieces of log data that match the detection rule as an erroneous detection amount of a phase corresponding to the detection rule.

14. The detection rule group adjustment apparatus according to claim 2,
wherein the processing circuitry
obtains the erroneous detection amount of each phase from a log analysis device, and
the log analysis device, using a plurality of pieces of log data that are produced while a target system is not receiving an attack, calculates a count of pieces of log data that match the detection rule as an erroneous detection amount of a phase corresponding to the detection rule.

15. The detection rule group adjustment apparatus according to claim 3,
wherein the processing circuitry
obtains the erroneous detection amount of each phase from a log analysis device, and
the log analysis device, using a plurality of pieces of log data that are produced while a target system is not receiving an attack, calculates a count of pieces of log data that match the detection rule as an erroneous detection amount of a phase corresponding to the detection rule.

16. The detection rule group adjustment apparatus according to claim 4,
wherein the processing circuitry
obtains the erroneous detection amount of each phase from a log analysis device, and
the log analysis device, using a plurality of pieces of log data that are produced while a target system is not receiving an attack, calculates a count of pieces of log data that match the detection rule as an erroneous detection amount of a phase corresponding to the detection rule.

17. The detection rule group adjustment apparatus according to claim 5,
wherein the processing circuitry
obtains the erroneous detection amount of each phase from a log analysis device, and
the log analysis device, using a plurality of pieces of log data that are produced while a target system is not receiving an attack, calculates a count of pieces of log data that match the detection rule as an erroneous detection amount of a phase corresponding to the detection rule.

18. The detection rule group adjustment apparatus according to claim 8,
wherein the processing circuitry
obtains the erroneous detection amount of each phase from a log analysis device, and
the log analysis device, using a plurality of pieces of log data that are produced while a target system is not receiving an attack, calculates a count of pieces of log data that match the detection rule as an erroneous detection amount of a phase corresponding to the detection rule.

19. A non-transitory computer readable medium storing a detection rule group adjustment program that makes a computer execute:
an erroneous detection amount obtaining process to obtain using an overall detection rule group corresponding to an overall phase group that configures a series of attack activities, an erroneous detection amount of each phase of when attack detection is performed;
a final stages verification process to verify based on an erroneous detection amount of each phase of a final phases group in the overall phase group, whether or not the erroneous detection amount of the final phases group satisfies a final stages limitation;
an overall verification process to verify based on the erroneous detection amount of each phase of the overall phase group, whether or not the erroneous detection amount of the overall phase group satisfies an overall limitation;
a final stages adjustment process, in a case where the erroneous detection amount of the final phases group does not satisfy the final stages limitation, to adjust a parameter value of each detection rule of a final stages detection rule group in the overall detection rule group; and
an overall adjustment process, in a case where the erroneous detection amount of the final phases group satisfies the final stages limitation and the erroneous detection amount of the overall phase group does not satisfy the overall limitation, to adjust a parameter value of each detection rule other than the final stages detection rule group in the overall detection rule group.
